(19) United States
(12) Patent Application Publication
(10) Pub. No.: US 2004/0186767 A1
(43) Pub. Date: Sep. 23, 2004

(54) System and method employing portable device for capturing and using broadcast source content to operate other digital devices

(76) Inventors: Yue Ma, West Windsor, NJ (US); Chieh-Chung Chang, Monmouth Junction, NJ (US); Rajesh Bhagwandas Khandelwal, Bridgewater, NJ (US); Eran Sitnik, Ossining, NY (US)

Correspondence Address: HARNESS, DICKEY & PIERCE, P.L.C., P.O. BOX 828, BLOOMFIELD HILLS, MI, 48303, US

(21) Appl. No.: 10/393,142

(22) Filed: Mar. 20, 2003

(51) Int. Cl. G06F 17/60

(52) U.S. Cl. 705/14

(57) ABSTRACT

A handheld device (such as a personal digital assistant or a cellular telephone) is capable of receiving digital information obtained from a broadcast source during, for example, the vertical blanking interval or from the Internet. The handheld device is capable of both formulating an instruction based on the digital information received and transferring the information and/or instruction to a remote electronic device. The instructions are used by the remote electronic device to perform a particular operation.

### FIELD OF THE INVENTION

The present invention relates generally to the use of broadcast source content to instruct the operation of other electronic devices. More specifically, the present invention relates the receipt of broadcast source content by a an personal information management (PIM) device or a electronic device part of a home network. The broadcast source content is comprised of digital data that is used by the PIM device or the device integrated within a home network to generate instructions that are then delivered to other electronic systems or devices for execution.

### BACKGROUND OF THE INVENTION

Digital data is widely available to consumers through various sources such as during the vertical blanking interval (VBI) of a television broadcast or through the Internet. The digital data received often includes information about a particular product for sale. Examples of product information available include the name of the product, a description of the product, the price of the product, stores offering the product, and directions to the stores offering the product. While this information is extremely useful, the user must manually transcribe the information to paper using a conventional writing utensil in order to make use of the information.

Consequently, there is a need for a device that is capable of directly receiving the digital information. The device may be any electronic device such as a personal digital assistant, cellular telephone, or home appliance. Once the device receives the digital information, the device will ideally provide an interface that will allow the user to easily store and recall the information for use at a later time. Further, the device will preferably be capable of interacting with other electronic devices or appliances, which may or may not be connected to a home network or the Internet, to transfer or deliver the information so as to execute a particular command.

### SUMMARY OF THE INVENTION

In accordance with the present invention, a handheld device (such as a personal digital assistant or a cellular telephone) or a networked appliance is capable of receiving digital information obtained from a broadcast source during, for example, the vertical blanking interval, a digital transport stream, from the Internet, and/or variety of other sources. The handheld device is further capable of both formulating an instruction based on the digital information received and transferring the information and/or instruction to a remote electronic device or appliance either through a hard wire connection or wirelessly. The instructions are used by the remote electronic device or appliances to perform a particular operation.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a system block diagram showing the general components of the invention, the invention providing a system and method employing a portable device or a networked appliance for using broadcast source content to operate other digital devices;

FIG. 2 is a system block diagram showing the detailed operation of the handheld device and the set-top box of FIG. 1;

FIG. 3 is a screen snapshot of the handheld device displaying live digital data received from a broadcast source, the data providing additional information concerning a product offered for sale;

FIG. 4 is a screen snapshot of the handheld device displaying live digital data received from a broadcast source, the data representing an electronic coupon;

FIG. 5 is an illustration of an EPG source table and a EPG data table;

FIG. 6 is a block diagram illustrating the construction of the EPG table and the construction of hyperlinks from one level of EPG information to another; and

FIG. 7 is a block diagram illustrating the construction of hyperlinks from level 2 EPG data to level 3 EPG data.

### DETAILED DESCRIPTION OF THE PREFERRED EMBODIMENTS

The following description of the preferred embodiment(s) is merely exemplary in nature and is in no way intended to limit the invention, its application, or uses.

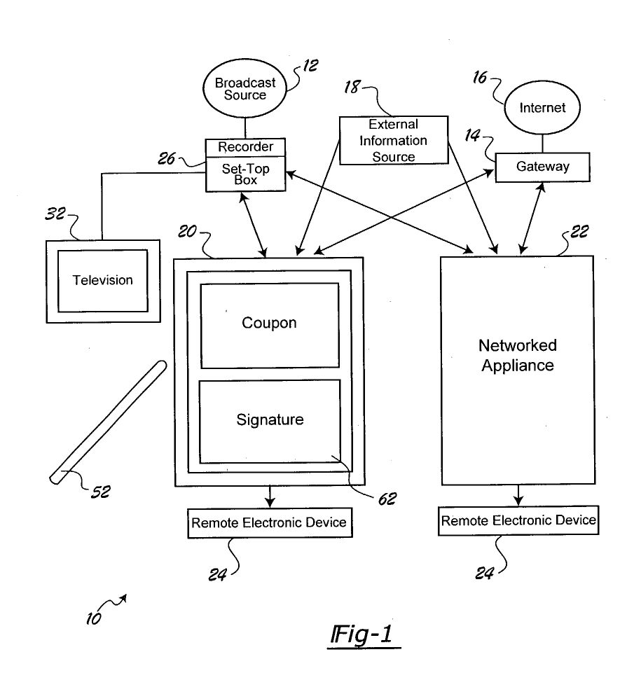

With reference to FIG. 1, a system 10 employing a portable device for using broadcast source content to operate other digital devices is illustrated. The system 10 generally comprises a broadcast source 12, an Internet gateway 14 connected to a Internet 16, an external information source 18, a handheld device 20 (such as a personal digital assistant (PDA) or a cellular telephone), a networked appliance 22 and a remote system or device 24 for receiving instructions from either the portable device 20 or network appliance 22.

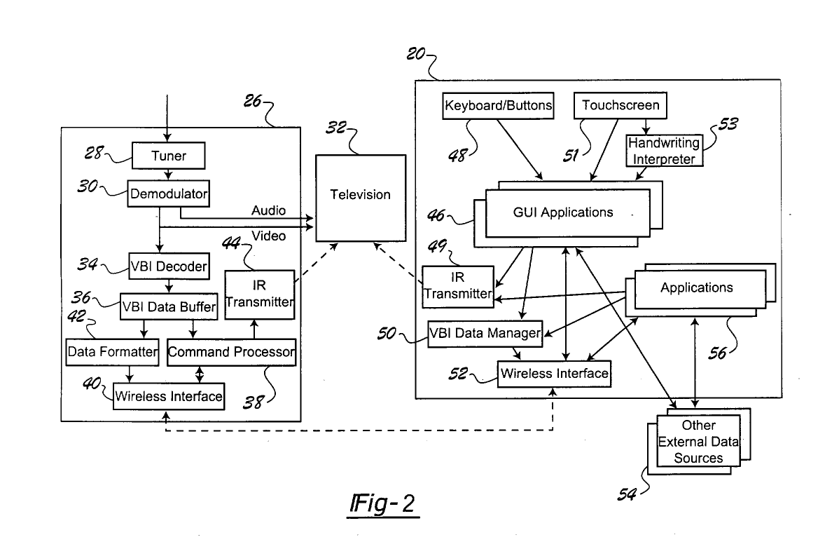

With continued reference to FIG. 1 and additional reference to FIGS. 2 through 12, the system 10 will now be described in further detail, preferably in accordance with the current analog TV broadcasting system. The broadcast source 12 produces a signal that carries both analog and digital data embedded within a vertical blanking interval (VBI) of the signal. While the analog data encodes television audio and video, the digital data may be used to represent virtually any type of data including data related to a product advertised by the broadcast source 12.

The signal produced by broadcast source 12 is received by set-top box (STB) 26. Specifically the signal is received by tuner 28 and then sent to demodulator 30 where the audio and video components are extracted from the signal. The audio component is sent directly to television 32 and the video component is sent to VBI decoder 34. The VBI decoder 34 is a hardware device that is capable of decoding the video data transmitted through the selected broadcast channel.

After the VBI data has been decoded by decoder 34 the data is stored in a VBI data buffer 36. The VBI data buffer 36 is necessary as VBI data is only sent at a certain time interval on each channel and thus can not be made instantaneously available when a user sends a request unless it has been previously saved. When VBI data is requested from a particular channel at a specific time, the data in the VBI data buffer 36 is looked for instead. This guarantees that VBI data will be available whenever it is requested. In order to insure that the correct data is provided to the user, all VBI data is channel and time stamped as will be more fully described below.

The STB 26 further comprises a command processor 38. The command processor 38 processes commands received from the handheld device 20 through a wireless interface 40 such as IEEE 803.11 b or Blue tooth. If a command requests VBI data from the broadcast source 12, the VBI data is retrieved from the VBI data buffer 36, formatted by data formatter 42 and sent back to the handheld device 20 using the same wireless interface 40.

If the handheld device 20 transmits a command to the STB 26 for controlling television 32, or any other audio/video device, the command is received by the command processor 38 and sent to an IR transmitter 44. The IR transmitter 44 allows the handheld device 20 to realize all of the control functions of the television 32, or any other audio/video device. Use of IR transmitter 44 allows the user to operate the television 32 without having to point the handheld device 20 at the television 32 and allows the distance for controlling the television 32 to be extended further than IR. The control capabilities are only limited by the capabilities of the wireless communication channel. It must be noted that the command signal may also be transmitted directly to the television 32 without being first sent to the STB 26.

It must be noted that while the tuner 28, demodulator 30, and VBI decoder 34 are shown in FIG. 2 to be located within STB 26, these components may be located in any other device such as a television. The decoded VBI signal may then be transmitted to either STB 26 or any suitable media bridge using by a general purpose data port (not shown).

The handheld device 20 will now be described in detail. As illustrated in FIG. 2, the handheld device 20 is operated by the user through the use of a graphical user interface (GUI) application 46. The GUI application 46 can be written using numerous programming languages such as JAVA. Inputs to the GUI may be made using a keyboard 48 or by touchscreen commands 50. Touchscreen commands may include the use of a writing implement, such as a stylus to enter handwritten commands recognized by a handwriting interpreter 53, further described in U.S. Provisional Application No. 60/370,561, filed on Apr. 5, 2002; the disclosure of the above application is incorporated herein by reference.

Commands entered via the GUI 46 may be directed to a variety of different locations as seen in FIG. 2. If the command is a direct operating command for television 32, or any other audio/video device, the command may be send to IR transmitter 49 for transmission directly to the television 32. If the command requests VBI data, the command may be sent to VBI data manager 50 for subsequent transmission to the STB 26 via wireless interface 52. However, it must be noted that the command may also be sent directly to the wireless interface 52 without first being sent to the VBI data manager 50. Wireless interface 52 may be any suitable interface such as Bluetooth, IEEE 802.11b, USB, or IR.

In addition to operating the GUI applications 46 using keyboard/buttons 48, touch screen 51, or handwriting interpreter 53, commands may also be provided by any other suitable external data source 54. Further, the external data source 54 may also be used to operate applications 56 that are not GUI applications 46 but are rather internal applications over which the user has no control. Commands generated by the internal applications 56 may be transmitted directly to television 32 via IR transmitter 49 or to STB 26 via wireless interface 52. Additionally, the commands generated by applications 56 may be first transmitted to the VBI data manager 50 and then subsequently transmitted to STB 26 through wireless interface 52.

Numerous different GUI's 46 may be used and FIGS. 8 and 9 represent one particular GUI 46 that may be used. The GUI 46 preferably has a menu bar 58 with numerous selection buttons 60 representing different functions of the handheld device 20. As illustrated in FIG. 3, the menu bar 58 may include selection buttons 40 labeled EPG (for obtaining electronic programming guide information), Live (for viewing the digital data associated with the viewed broadcast), Remote (for operation of the television 32 and other audio/video devices), and Clips (for viewing previously downloaded media clips). The buttons 60 may be selected in any suitable manner but are preferably selected using stylus 52.

Using the stylus 52, most commands are entered by tapping directly on screen 62 of device 20. However, when the commands require text or when the user desires to use text to convey his/her commands, handwritten commands may be entered directly upon screen 62. The handwritten commands are then interpreted using a handwriting recognition and search engine 52 as described above.

The handwriting recognition and search engine 52 matches the handwritten commands entered to the available functions of device 20. For example, once a text command is entered, the GUI 46 searches the available commands and returns a list of commands approximating that entered by the user. The user is then able to select the particular command represented by his/her text input from the list.

The handwriting recognition and search engine 46 is particularly useful for selecting the particular channel from which to receive digital data. For example, if the user desires to receive digital data from the Cable News Network, the user only needs to enter “CNN” upon screen 62. Once the user enters the letters CNN, a listing of TV stations with names approximating the entry appears automatically upon the screen 62 of the handheld device 20 with the closest match appearing at the top of the list. The user may then select from the list the station with the program that he/she wishes to view or the data that he or she wishes to receive. In addition to writing the name of the channel from which to receive data, the user may also enter the a general description of a program, such as “comedy starring Woody Allen.”

If a command is entered using the GUI 46 requesting data received by the STB 26 during the VBI, such as detailed information concerning a commercial product, the request is sent to the STB 26. Once the command is received by the STB 26, the request is transferred to the command processor 38. As described above, the command processor 38 then retrieves the requested data from the VBI data buffer 36. The requested data is then sent back to the device 20 through the same channel in which it was sent.

Once the requested data is received by the handheld device 20, the data is stored locally by the VBI data manager 50 for presentation to the user by way of the GUI 46. The data remains stored by the VBI data manager 50 even after the connection between the device 20 and the STB 26 is terminated and may therefore be carried away with the handheld device 20. Data may be stored within the VBI data manager 50 using any suitable format but is preferably stored in XML so as to ease translation between the device 20 and various types of content from different providers.

VBI data stored in XML must be interpreted before it may be used. Interpretation of VBI data is performed by a VBI data (XML) parser (not shown), which can be implemented in software using programming languages such as C++, Java, or Perl.

Certain data received during the VBI, such as EPG or detailed information concerning an advertised product, may also be obtained from other sources such as the Internet 16 via Internet gateway 14. As a result, the data received from the other sources must be synchronized. Synchronization is carried out by a synchronization engine. Detailed operation of the synchronization is provided in FIGS. 10 through 12.

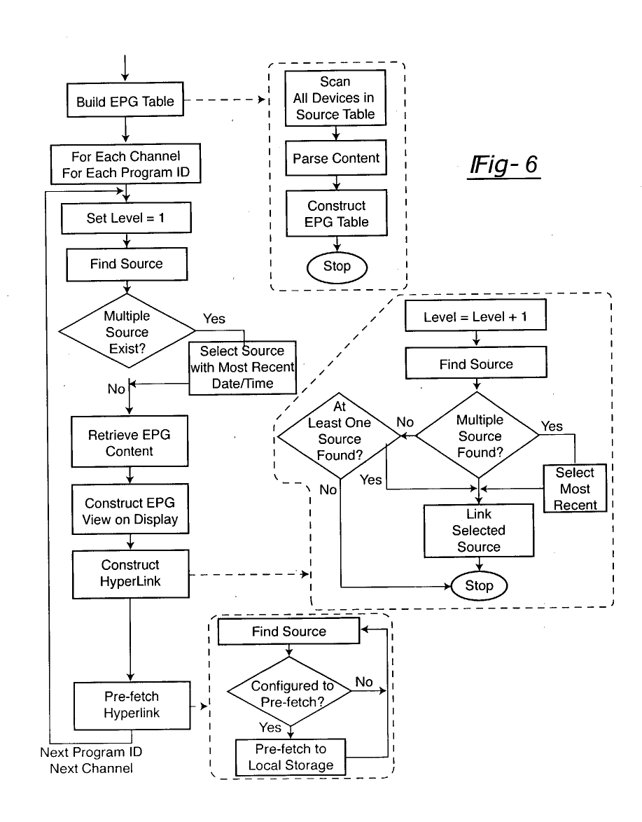

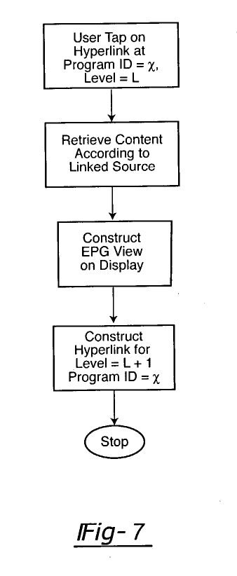

The synchronization is realized through a structured data format in representing the EPG contents. Particularly, a source table and an EPG table are constructed from downloaded EPG contents as shown in FIG. 5. The synchronization engines uses the siurce table to build the EPG table, and synchronize various contents using the XML structured tags. The details are illustrated in FIG. 6. In synchronization, hyperlinks between different contents are built and different views of EPG contents can be invoked from other contents via the hyperlink. Upon click on the hyperlink, another view of the EPG is constructed from the EPG contents database, and this action is illustrated in FIG. 7. Notably, the data synchronization is accomplished in the example through the use of XML format. It should be readily understood, however, that the synchronization engine can also support syncML standard markup language and/or equivalents as needed. Further information on the synchronization can be found in U.S. Provisional Application No. 60/370,496, filed on Apr. 5, 2002; the disclosure of the above application is incorporated herein by reference. Yet further information on the synchronization can be found in U.S. Provisional Application No. 60/370,446, filed on Apr. 5, 2002; the disclosure of the above application is incorporated herein by reference.

The use of device 20 to carry out specific operations will now be described in detail. If the user selects the button 60 labeled “Live,” the device 16 will access digital data transmitted to STB 26 in association with the program currently being viewed. As described above, the data is transferred from the STB 26 to the handheld device 20 where it is made available to the user via the GUI 46. The digital data may include a variety of different types of information, with the information being used by the device 20 to carry out a variety of different operations. The following discussion presents examples of information that may be received by device 20 and examples of how that information may be used by device 20 to operate other remote electronic devices 24.

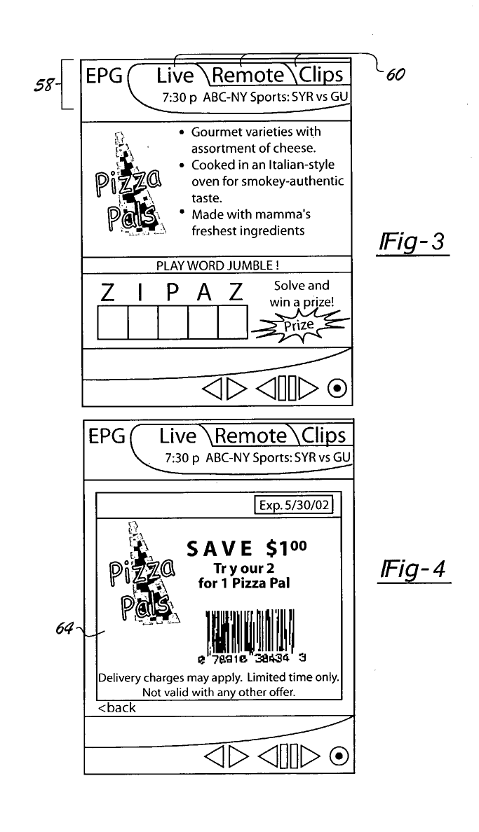

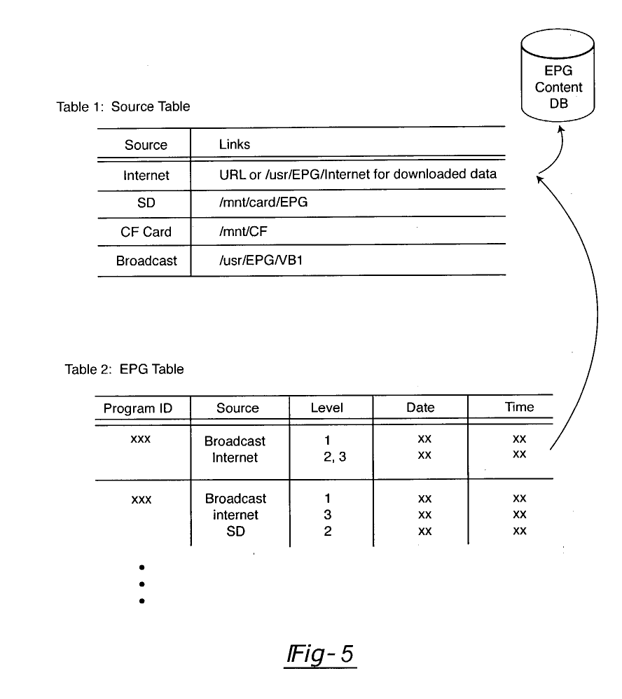

Digital data associated with a particular channel may be widely used to promote commercially available products. The promoted products are preferably either related to the program being viewed or are products that would likely appeal to the average viewer of the program. For example, if the viewed channel is broadcasting a commercial for Pizza Pal (FIG. 3), selection of the button 60 labeled “Live” would preferably present the user with information concerning Pizza Pal products. To enhance the user's viewing experience, the user may also be presented with a game concerning the product advertised. If the user chooses to play the game and plays successfully, the user would be presented with a reward, such as a digital coupon 64 for a discount on the advertised product (FIG. 4). The coupon 64 would be downloaded and stored within the VBI data manager 50 according to the above described process. Upon arrival at the store, the use could link his/her handheld device 20 to an electronic device 24 that would then be able to read the coupon 64 and directly apply the discount to the user's final bill.

In addition to providing the user with a digital coupon for a discount on the final product purchased, the user could also receive detailed information for locating the nearest store selling the advertised product. For example, the digital data may represent driving instructions that could then be stored in the VBI data manager 50 and read by a satellite navigation system (represented in FIG. 1 at 24), thus allowing the satellite navigation system 24 to lead the user directly to the store.

In addition to receiving directions to the store, the user could also be provided with monetary credits covering expenses associated with the user's trip to the store. For example, if the satellite navigation system senses that the user must pay a toll to visit the store, a digital coupon equal to the price of the toll could be provided to the user. The coupon could then be redeemed through interaction of the device 20 with an electronic toll debit system (represented in FIG. 1 at 24), thus allowing the user to pass through the toll booth without having to pay the toll.

In a similar fashion, the user could be presented with a coupon for gas, parking, or public transit fare. In each situation, as discussed above, the handheld device 20 would transmit the coupon to a suitable device, such as an electronic parking meter, an electronic gas pump, or an electronic fare machine, (all represented in FIG. 1 at 24) so as to provide the user with free parking, gas, or public transport in order to visit the store.

If the user is viewing a commercial for computer software, the handheld device 20 may be configured to receive a sample version of the software program. The software program could then be transmitted to the user's personal computer (represented in FIG. 1 at 24). The software would stay active on the computer for a period of time before the free trial terminates, after which the user would have to purchase a full version of the program in order to operate the program.

It must be noted that in addition to receiving data from broadcast signal 12, the device 20 may also receive data from the Internet 16 or an external information source 18, such as an SD card or compact disk. Internet 16 and external information source 18 may provide the same product related information discussed above and may also be capable of providing even more detailed information.

While the above discussion focuses on handheld device 20, it must be noted that the data from broadcast source 12, external information source 18, or the Internet 16 may also be provided to any other device such as a home networked appliance 22. The appliance 22 may be any electronic device such as a refrigerator, an oven, microwave, VCR, or DVD player. Thus, the invention as described above may be less handheld-centric by spreading the functionality of the handheld device 20 to other networked appliances 22.

As an example, a user using his/her oven to receive Internet data via gateway 14 to receive cooking recipe information may receive advertising information regarding one or more of the ingredients called for in the recipe. The advertising information may include navigational information to direct the user to a store offering the ingredients. The navigational information could be then transferred to a handheld GPS device (illustrated at 24) so as to direct the user to the store offering the product.

Further, data such as EPG data may be viewed using a networked appliance 22 such as a refrigerator. If the user locates a particular show that he or she wishes to record, the user may interact with the appliance 22 so as to transmit a command through the home gateway to another appliance 22 connected to the gateway such as a VCR. The VCR could then be programmed remotely to record the desired television show.

It must be noted that while the above invention places emphasis on the use of VBI data, the invention may also be used with digital television. Specifically, in a digital video implementation, program content and digital data content may be combined directly as digital video content. In this regard, the current MPEG-2 standard defines protocols by which both program content and data content can be combined for delivery to the customer.

Finally, it must be noted that either the device 20 or the networked appliance 22 may be outfitted with a text to speech device so as to allow the data received to be presented orally to the user. Further, if the user is not proficient in the language used by the device 20, or the networked appliance 22, a translation device may be used to translate data received and entered into the user's native language.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A hand-held device adopted to affect operation of a remote device based on information extracted from a broadcast signal, comprising:
an input adapted to receive the information extracted from a broadcast signal;
an instruction formulation module operable to formulate an instruction adapted to operate the remote device based on the information; and
an output adapted to communicate the instruction to the remote device, thereby affecting operation of the remote device based on the information extracted from the broadcast signal.

2. The device of claim 1, wherein said input is adapted to receive software corresponding to an interactive game extracted from the broadcast signal, and said instruction formulation module operable to formulate the instruction based on the game.

3. The method of claim 1, wherein said input is adapted to receive trial software extracted from the broadcast signal, and said instruction formulation module operable to formulate the instruction based on the trial software.

4. The device of claim 1, wherein said input is adapted to receive an electronic coupon extracted from the broadcast signal, and said instruction formulation module operable to formulate the instruction based on the coupon.

5. The device of claim 4, wherein the coupon applies to ingredients in a recipe.

6. The device of claim 1, wherein said input is adapted to receive driving directions extracted from the broadcast signal, and said instruction formulation module operable to formulate a navigational instruction based on the driving directions.

7. The device of claim 1, wherein said input is adapted to receive monetary credits extracted from the broadcast signal, and said instruction formulation module operable to formulate at least one of an account debit instruction and an account credit instruction based on the driving directions.

8. The device of claim 7 wherein the monetary credits are redeemable for an expense incurred by a user in traveling to a location to purchase an advertised product.

9. The device of claim 1, comprising:
an device interface adapted to communicate with a remote device adapted to acquire information over a communications network; and
a synchronization engine adapted to link information extracted from the broadcast signal to related information acquired over the communications network.

10. The device of claim 9, wherein the information extracted from the broadcast signal is a recipe and the related information is a coupon for an ingredient of the recipe.

11. The device of claim 1, wherein said output is adapted to communicate instructions to a translation-capable remote device adapted to translate instructions from one language to another, thereby affecting translation of the instructions from one language to another.

12. A method of operation for use with a hand-held device, comprising:
receiving information extracted from a broadcast signal;
formulating an instruction adapted to operate a remote device based on the information; and
communicating the instruction to the remote device, thereby affecting operation of the remote device based on the information extracted from the broadcast signal.

13. The method of claim 12 comprising:
receiving software corresponding to an interactive game extracted from the broadcast signal; and
formulating an instruction based on the game.

14. The method of claim 12 comprising:
receiving trial software extracted from the broadcast signal; and
formulating an instruction based on the trial software.

15. The method of claim 12 comprising:
receiving an electronic coupon extracted from the broadcast signal; and
formulating an instruction based on the coupon.

16. The method of claim 12 comprising:
receiving an electronic coupon extracted from the broadcast signal, wherein the coupon applies to ingredients in a recipe; and
formulating an instruction based on the coupon.

17. The method of claim 12 comprising:
receiving driving directions extracted from a broadcast signal; and
formulating a navigational instruction based on the driving directions.

18. The method of claim 12 comprising:
receiving monetary credits extracted from a broadcast signal; and
formulating at least one of an account debit instruction and an account credit instruction based on the driving directions.

19. The method of claim 18 wherein the monetary credits are redeemable for an expense incurred by a user in traveling to a location to purchase an advertised product.

20. The method of claim 12 comprising:
communicating with a remote device adapted to acquire information over a communications network; and
linking information extracted from the broadcast signal to related information acquired over the communications network.

21. The method of claim 20, wherein the information extracted from the broadcast signal is a recipe and the related information is a coupon for an ingredient of the recipe.

22. The method of claim 12 comprising:
communicating with a translation-capable remote device adapted to translate instructions from one language to another; and
communicating instructions to the translation-capable remote device, thereby affecting translation of the instructions from one language to another.
